(19) United States
(12) Patent Application Publication
(10) Pub. No.: US 2002/0027941 A1
(43) Pub. Date: Mar. 7, 2002

(54) Method and apparatus for detection of defects using localized heat injection of narrow laser pulses

(76) Inventors: Jerry Schlagheck, West Chester, OH (US); Marc Pastor, St.-Hubert (CA)

Correspondence Address: OGILVY RENAULT, 1981 MCGILL COLLEGE AVENUE, SUITE 1600, MONTREAL, QC, H3A2Y3, CA

(21) Appl. No.: 09/986,712

(22) Filed: Nov. 9, 2001

Related U.S. Application Data
(63) Continuation-in-part of application No. 09/648,140, filed on Aug. 25, 2000.
(60) Provisional application No. 60/254,666, filed on Dec. 11, 2000.

(51) Int. Cl. G01N 25/72

(52) U.S. Cl. 374/5

(57) ABSTRACT

A method for inspecting an object and detecting defects is taught (BGA and Flip-Chip solder joints on a PCB particularly). The method comprises injecting a heat pulse by light beam at a selected point on the object; capturing a sequence of consecutive thermal images of the object to record heat diffusion over time resulting from the heat pulse; comparing the heat diffusion over time at the point on said object to a reference; and determining whether the object comprises any defects. Also taught is an apparatus comprising a mounting for mounting the object; a pulsed laser source having a beam able to be positioned for providing a heat pulse at a precise location on the object; a thermal camera for capturing thermal images of the object; a frame grabber for capturing a sequence of image signals from the thermal camera; a memory unit for storing data representative of heat diffusion over time resulting from the heat pulse obtained from the sequence of image signals; and an analyzing unit for comparing the heat diffusion data to a reference data set, said reference comprising upper and lower limits of acceptable thermal heat diffusions of a specific area on the object.

### CROSS-REFERENCE TO RELATED APPLICATIONS

The application claims priority of U.S. provisional application serial No. 60/254,666 filed on Dec. 12, 2000 entitled “Detection of Defects by Thermographic Laser Analysis” and is a continuation in part of U.S. patent application Ser. No. 09/648,140 filed Aug. 25, 2000, now pending.

### FIELD OF THE INVENTION

The invention relates to the field of industrial inspection. More specifically, it relates to the inspection of the quality and integrity of junctions and connections, such as those for devices mounted on Printed Circuit Boards (PCB).

### BACKGROUND OF THE INVENTION

It is known in the art that an object such as a populated circuit board may be inspected for defects by a procedure wherein such a board is heated in order to obtain a thermal image via an infrared (IR) camera. The captured image is then compared to a standard thermal image of a known defect-free populated circuit board in order to evaluate the quality of the connections and junctions on the tested board. What varies in the state of the art is the way the object under inspection is heated.

For example, U.S. Pat. No. 5,052,816 discloses a method and apparatus for junction inspection of electronic parts wherein a plurality of lead wires such as those from an IC (an integrated circuit) are irradiated by a fan beam at the same time. U.S. Pat. No. 5,208,528 discloses a method for inspecting a PCB, and particularly for inspecting solder joints on the board. This method is characterized by the heating of the board, which is done either by pulsed or brief heating, or in a laminar fashion using a quartz lamp. U.S. Pat. No. 5,246,291 teaches a bond inspection technique for a semiconductor chip wherein a bonding process heats each package lead bonded to each contact area and an IR camera captures an intensity image. A laser can also be used to heat the leads, heating a plurality of leads at once. U.S. Pat. No. 5,984,522 discloses an apparatus for inspecting bump junctions in a semiconductor flip chip mounting wherein the surface of the semiconductor bare chip is irradiated with a laser light and radiation heat from the heated chip is detected with an IR camera.

From the above referenced patents, it is clear that a thermal image can be captured by an IR camera and that this image can be used to detect defects on a PCB. What is also clear is that obtaining thermal images with respect to individual solder junctions would provide an incredible advantage over the state of the art. It would also be advantageous to be able to selectively heat a pre-selected area of a PCB adjacent to a predetermined solder joint or junction.

Moreover, since it is essential to detect defects of electronic components such as Ball Grid Arrays (BGA), Flip Chips, and semi-conductor devices, there is a need to provide an inspection technology which is relatively easy to use, reliable, and can selectively identify defects due to absence, poor quality, or out of tolerance of a solder joint.

### SUMMARY OF THE INVENTION

Accordingly, an object of the present invention is to detect defects such as missing balls, misaligned balls, extra parts between balls, solder bridges between two adjacent balls, cracks at the junction ball-copper pad, and voids in balls of a ball-grid array component mounted on printed circuit boards.

Another object of the present invention is to detect anomalies in junctions between flip chips and printed circuit boards.

Accordingly, another object of the present invention is to use a light beam, collimated, converging or diverging, to deliver a heat pulse, or stream of heat pulses, to a very small area of a printed circuit board.

According to a first broad aspect of the present invention, there is provided a method for inspecting an object and detecting defects, the method comprising: injecting a heat pulse by light beam at a selected point on the object; capturing a sequence of consecutive thermal images of the object to record heat diffusion over time resulting from the heat pulse; comparing the heat diffusion over time at the point on said object to a reference; and determining whether the object comprises any defects.

Preferably, the method is to be used for detecting anomalies in solder junctions of ball-grid arrays and flip chips mounted on printed circuit boards. The heat pulse is to be directed to the bottom surface of the board, producing infrared emissions at the top surface of the component as the heat is diffused through the board and the electronic component. An infrared camera captures a sequence of thermal images and compares the data to reference data gathered from known defect-free boards.

Also preferably, an entire sequence of points on a board is programmed into the system and each point is consecutively inspected without human intervention. The board or the area to be inspected is given time to return to ambient temperature in between inspection of each point.

According to a second broad aspect of the invention there is provided an apparatus for inspecting an object and detecting defects, the apparatus comprising: a mounting for mounting the object; a pulsed laser source having a beam able to be positioned for providing a heat pulse at a precise location on the object; a thermal camera for capturing thermal images of the object; a frame grabber for capturing a sequence of image signals from the thermal camera; a memory unit for storing data representative of heat diffusion over time resulting from the heat pulse obtained from the sequence of image signals; and an analyzing unit for comparing the heat diffusion data to a reference data set, said reference comprising upper and lower limits of acceptable thermal heat diffusions of a specific area on the object.

Preferably, the apparatus also comprises an X-Y galvanometer to align the pulsed laser source with the precise location on the object. The apparatus can also comprise focusing optics to converge, diverge, and deflect the laser beam coming from the pulsed laser source, an optical power attenuator to adjust power of the heat pulse, and an input/output interface to control the X-Y galvanometer, the pulsed laser source, and the optical power attenuator.

Also preferably, The mounting comprises register pins to properly fix in space the object under inspection. The mounting can also comprise a stage that allows the object to be moved in the x, y, and z directions.

### BRIEF DESCRIPTION OF THE DRAWINGS

These and other features, aspects and advantages of the present invention will become better understood with regard to the following description and accompanying drawings wherein:

FIG. 1 is a schematic diagram illustrating an embodiment of the present invention;

FIG. 2 is a block diagram of the Computer system controlling the apparatus;

FIG. 3 is a schematic diagram illustrating an embodiment of the LASER unit;

FIG. 4. is a schematic diagram illustrating heating a solder joint;

### DETAILED DESCRIPTION OF THE PREFERRED EMBODIMENT

While illustrated in the block diagrams as ensembles of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

Although this detailed description refers mainly to the inspection of defects on printed circuit boards and between soldered electrical components and the board, it can be appreciated that the method taught can be applicable to detect defects of any type of object for which heat diffusion over time can be measured.

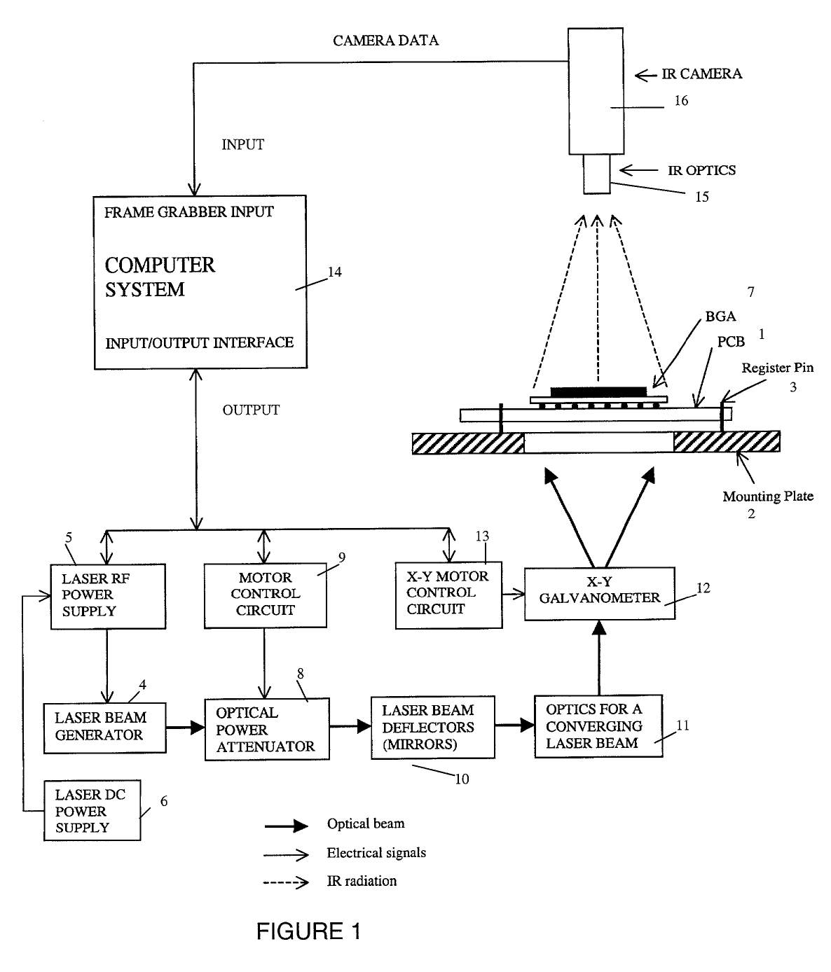

FIG. 1 illustrates an apparatus for inspecting the quality and integrity of junctions and connections of parts of a semi-conductor device, such as BGA and flip-chip, mounted on a PCB. A PCB 1 is mounted on a mounting plate 2, register pins 3 are used to properly align the board and to ensure a precise positioning in space with respect to the light beam and the camera. The junction points of the BGA 7 to the board are hidden and inaccessible visually. A computer system 14 selects a programmed ball position by setting the X-Y motor control circuit 13 of the X-Y galvanometer 12. The computer then fires the laser beam generator 4, powered by a LASER Radio Frequency (RF) power supply 5 and a LASER DC power supply 6, supplying an optical beam to an optical power attenuator 8. The attenuator 8 is controlled by the motor control circuit 9 and transmits the optical beam to laser beam deflectors 10 and optics for a converging a beam 11 until the optical beam reaches an X-Y galvanometer 12. The galvanometer 12, controlled by the X-Y control circuit 13, is responsible for directing the optical beam towards a selected area of the mounting plate 2 and selectively heating one or more balls in the BGA 7 through the PCB 1.

Once the heat propagates through the material and appears at the top surface of the BGA, the IR camera 16 captures a thermal image, transforms the IR radiation of the thermal signature into electronic data and sends it to the computer system 14 to be captured and analyzed. The IR optics 15 maximize the field of view to get the maximum spatial resolution for the best performances.

The main parts of the computer system 14, which are not explicitly shown in the figure, are a frame grabber to capture analog or digital data from the IR camera 16 and to store in the PC memory, an input/output Interface to control the Laser Pulses, the programmable optical power attenuator 8 and the X-Y galvanometer scanner 12 positions, and an application software to learn a “good” or acceptable thermal ball pattern and to compare the thermal ball pattern under test with some stored reference (dual threshold statistical acceptance criteria, min-max acceptance criteria or any mean to accept/reject a pixel or a pattern). Comparison between two thermal patterns is processed and done by the computer system 14. The computer system 14 captures and stores the specified sequence of images in the PC with the proper synchronization. These images are processed and some intermediate results of the test may be provided. The computer system 14 then selects the next ball position to be inspected and the process is repeated. When all the specified balls have been tested, the BGA capture sequence and storage is completed and the computer processes all the specified balls and outputs a complete result for the entire BGA under inspection.

For a typical BGA/PCB, the pulse duration may vary between 100 to 200 ms with an average power of 2 Watts with a CO₂ LASER, which means an energy between 200 to 400 mJ. This energy is concentrated on a spot size of around 1 mm to 4 mm in diameter at 1/e² at the nominal ball location. The time for the heat pulse to propagate is in the order of 200 to 500 ms. The IR camera 16 will capture consecutive images at a rate of 30 to 60 frames per second, depending on the transmit time of the heat. The LASER pulse is also synchronized with the frame timing of the camera. Another type of LASER, such as YAG or a laser diode, can be used to implement the necessary heat source. In this case, the wavelength and power used changes.

In an alternative embodiment of the system, instead of having an X-Y galvanometer to direct the laser beam to the board, the laser is fixed and it is the mounting plate that is moveable. The mounting plate, with the PCB in a fixed position on it, can move in the x, y, and z position in order to properly align the board and the laser.

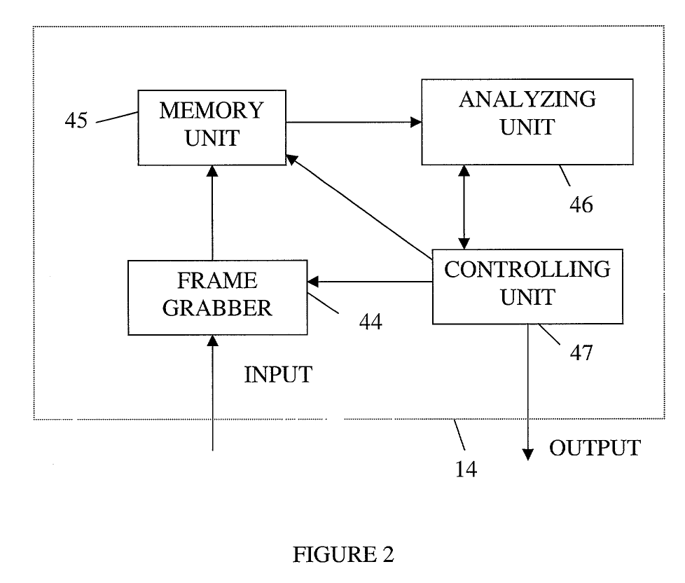

FIG. 2 is a block diagram representing module 14 of FIG. 1. A frame grabber 44 captures a sequence of image signals from the thermal camera 43 and specific points in time following the heating of the board by the pulsed laser source 41. A memory unit 45 stores data representative of heat diffusion over time resulting from the heat pulse and obtained from the sequence of image signals. This information is then passed on to an analyzing unit 46 to compare the heat diffusion data to a reference data set. The reference data set comprises upper and lower limits of acceptable thermal heat diffusions for a specific area on the board and at a specific point in time following the heating. This reference data is collected from known defect-free boards and averaged out to produce an acceptable range. A controlling unit 47 controls all other modules within the computer system 14. It also controls the X-Y galvanometer 12, the laser beam generator 4, and the optical power attenuator 8. The controlling unit 47 may comprise a programmed sequence of points to which the laser beam must be targeted and is responsible for directing the laser beam to each of these points sequentially.

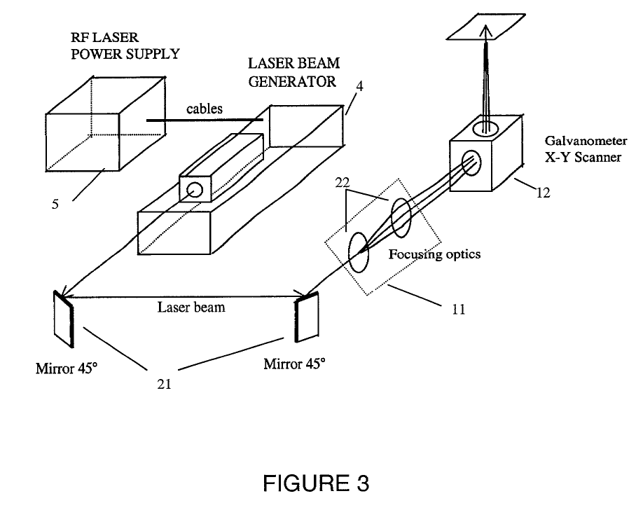

FIG. 3 is a physical description of the preferred embodiment of the laser unit. The RF LASER power supply 5 and the LASER beam generator 4 are connected by electrical cables. The LASER beam generator 4 generates sufficient optical power at such a wavelength to be able to induce a heat spot at the bottom surface of the PCB. In a preferred embodiment, the LASER may be a CO₂ LASER (10.6 μm wavelength) with a 25 to 50 Watts continuous waveform. The LASER beam deflector unit 10 comprises two small, flat mirrors 21, each angled at 45 degrees in order to reflect the beam towards the optics for a converging LASER beam 11. The optics for a converging LASER beam 11 comprises several lenses 22 used to focus and collimate the beam before sending it into the X-Y galvanometer scanner 12. The X-Y galvanometer scanner 12 comprises of two orthogonal flat mirrors mounted on two motor axis (not shown). The two motors are positioned from the computer through proper electronic/electrical interfaces. The LASER beam is concentrated to have an adjustable spot size of around 1 mm to 4 mm in diameter at 1/e². This light spot covers the area where the ball under inspection is located. When this area has been heated by the pulse, the X-Y galvanometer scanner 12 addresses the next ball to be inspected and the LASER is fired again for the same short period of time. The RF LASER power supply 5 provides the RF energy to stimulate the CO₂ LASER which will output the light beam during the time this RF energy is present. When this RF energy is absent, the LASER will stop lasing immediately. The RF LASER power supply 5 also monitors and controls the pulse duration and repetition rate through electronic signals coming from the computer input/output interface.

The system of the present invention must be calibrated before a PCB is tested and analyzed. The calibration step is carried out in order to obtain and store in computer memory the parameter settings (i.e. intensity, shape, duration, repetition rate, etc.) for the comparison of the tested PCB with an acceptable range for a thermal signature. To produce the acceptable range, approximately 15 to 30 thermal images are taken of known defect free samples and the mean and the standard deviation are calculated for every pixel of each frame. The upper and lower limits of the acceptance range is then calculated (user will set the number of standard deviations) for every pixel and stored as the standard to which all tested boards are compared to. Furthermore, in order to remove all possible variants of heat that may act on a board to be tested, a first image is taken of the PCB before being heated by the laser. This first image is then subtracted from all subsequent images taken of the same board in order to take into account all ambient and variation effects.

Note that when an element is heated, the heat injected must always be the same. This is only achievable when using a laser to heat the element. Furthermore, it should also be noted that when two thermal images are compared, they must have been taken at the same point in time. Therefore, the system is working with four variables: two positional (x, y), one thermal (heat intensity), and one for time. The threshold for the intensity of the laser is the damage threshold. That is, the amount of energy injected is only as high as the amount of heat applicable that will not cause any damage to the board or the elements.

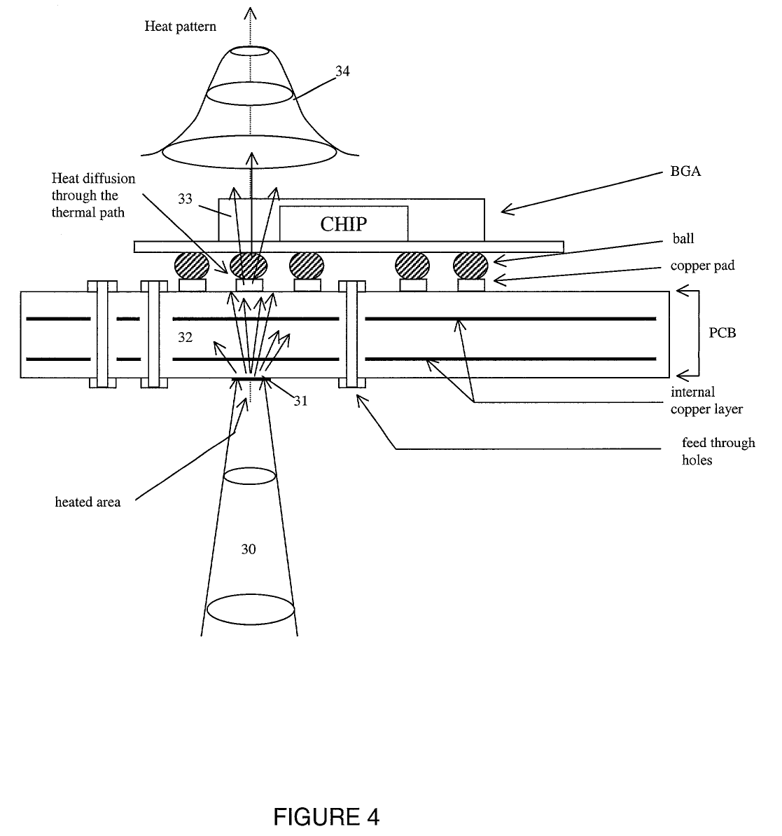

FIG. 4 is a close-up schematic of the heating of a solder joint. A light beam 30 is positioned under a ball from a ball-grid array. The laser light pulse heats the small area 31. Heat propagates through the materials 32 and appears at the BGA top surface 33. A radiation pattern 34 is then captured by an infrared camera. From the drawing, the junction point between the ball and the PCB is quite clear. This particular embodiment makes use of transmissive heating. However, it is possible to do reflective heating. In this case, a light beam is placed above the BGA at an angle to the desired area to be heated in order to keep the path between the BGA and the infrared camera clear.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for inspecting an object and detecting defects, said method comprising:
injecting a heat pulse by light beam at a selected point on said object;
capturing a sequence of consecutive thermal images of said object to record heat diffusion over time resulting from said heat pulse;
comparing said heat diffusion over time at said point on said object to a reference; and
determining whether said object comprises any defects.

2. A method as claimed in claim 1, wherein said injecting a pulse by light beam comprises directing heat to a bottom surface of said object, said heat transmitting through a top surface of said object.

3. A method as claimed in claim 1, wherein said capturing a sequence of consecutive thermal images comprises capturing a first image prior to said injecting a heat pulse.

4. A method as claimed in claim 3, wherein comparing further comprises subtracting data of said first image from data of subsequent images taken after said injecting a heat pulse in order to remove ambient and variation effects.

5. A method as claimed in claim 1, wherein said step of comparing said heat diffusion over time at said point on said object to a reference comprises comparing an area of interest surrounding said point on a sequence of images to an area of interest surrounding said point on a sequence of reference images.

6. A method as claimed in claim 5, wherein said reference images are the average of a plurality of images of known defect-free objects.

7. A method as claimed in claim 1, further comprising the steps of:
holding said object in place, ensuring a precise positioning in space;
maintaining said object at a stable temperature;
programming an entire set of points on said object to be inspected;
injecting a heat pulse by light beam at a next point on said object, said next point determined by said set of points;
repeating said step of injecting a heat pulse by light beam at a next point on said object until all points in said entire set of points have been inspected;
providing a compilation of results to produce a complete analysis after said entire set of points on said object has been inspected.

8. A method as claimed in claim 7, further comprising the step of waiting for temperature of at least one of said object and an area to be inspected to return to an ambient temperature before said repeating said step of injecting a heat pulse by light beam.

9. A method as claimed in claim 1, wherein said light beam is collimated, redirected, and modified to provide maximum heat power without damaging said object's surface.

10. A method as claimed in any one of claims 1 to 9, wherein said object is a populated board.

11. A method as claimed in claim 10, wherein ball-grid arrays are mounted on said populated board and said defects to be detected are the quality and integrity of solder junctions between said populated board and said ball-grid arrays.

12. A method as claimed in claim 10, wherein flip chips are mounted on said populated board and said defects to be detected are the quality and integrity of connections between said flip chips and said populated board.

13. A method as claimed in claim 11, wherein each said heat pulse is directed to a point beneath a solder joint that will allow the maximum amount of injected heat to reach said solder joint.

14. A method as claimed in claim 13, wherein each point in said set of points corresponds to a ball in a ball-grid array.

15. A method as claimed in claim 7, wherein said object is a populated board and said populated board is held in a precise position in space by mounting said populated board onto register pins.

16. A method as claimed in claim 1, wherein an energy of said heat pulse is varied depending on a position within said populated board in order to optimize imaging of said heat diffusion.

17. An apparatus for inspecting an object and detecting defects, said apparatus comprising:
a mounting for mounting said object;
a pulsed laser source having a beam able to be positioned for providing a heat pulse at a precise location on said object;
a thermal camera for capturing thermal images of said object;
a frame grabber for capturing a sequence of image signals from said thermal camera;
a memory unit for storing data representative of heat diffusion over time resulting from said heat pulse obtained from said sequence of image signals; and
an analyzing unit for comparing said heat diffusion data to a reference data set, said reference comprising upper and lower limits of acceptable thermal heat diffusions of a specific area on said object.

18. An apparatus as claimed in claim 17, further comprising an X-Y galvanometer to align said pulsed laser source with said precise location on said object.

19. An apparatus as claimed in claim 18, further comprising a controller programming an entire sequence of points on said object and causing said X-Y galvanometer to sequentially target each point of said sequence of points.

20. An apparatus as claimed in claim 18, further comprising
focusing optics for converging, diverging, and deflecting said pulsed laser source;
an optical power attenuator to adjust power of said heat pulse; and
an input/output interface to control said X-Y galvanometer, said pulsed laser source, and said optical power attenuator.

21. An apparatus as claimed in claim 17, wherein said mounting means further comprises register pins.

22. An apparatus as claimed in claim 17, wherein said mounting comprises a stage allowing said object to be moved in the x and y direction.

23. An apparatus as claimed in claim 22, wherein said mounting can also move in the z direction.

24. An apparatus as claimed in claim 22, further comprising a controller programming an entire sequence of points on said object and causing said mounting to align sequentially each point of said sequence of points on said object to said pulsed laser source.
